(19) United States
(12) Patent Application Publication
(10) Pub. No.: US 2023/0331759 A1
(43) Pub. Date: Oct. 19, 2023

(54) LIQUEFACTION PROCESS FOR THE RECOVERY OF HOMOGENEOUS LIGNIN

(71) Applicant: Ford Global Technologies, LLC, Dearborn, MI (US)

(72) Inventors: Alper Kiziltas, Sarikamis (TR); Xinfeng Xie, Houghton, MI (US); Peng Quan, Houghton, MI (US); Deborah Frances Mielewski, Ann Arbor, MI (US)

(73) Assignee: Ford Global Technologies, LLC, Dearborn, MI (US)

(21) Appl. No.: 17/722,997

(22) Filed: Apr. 18, 2022

(51) Int. Cl. C07G 1/00

(52) U.S. Cl. CPC C07G 1/00

(57) ABSTRACT

A method for the recovery of lignin includes dissolving black liquor in solvent to form a mixture having a pH greater than or equal to about 12 to less than or equal to about 14. The pH of the mixture is then adjusted to greater than or equal to about 3 to less than or equal to about 7. The mixture is liquefacted, which includes increasing a temperature of the mixture to a target temperature, maintaining the target temperature for a period of time, and cooling the mixture to room temperature. Following liquefaction, the mixture is filtered to separate soluble and insoluble fractions of the mixture. The soluble fraction includes a lignin product having a polydispersity greater than or equal to about 1.78 to less than or equal to about 2.56.

### FIELD

The present disclosure relates to a method for the separation of lignin from spent cooking liquor, i.e., black liquor generated during pulping processes.

### BACKGROUND

The statements in this section merely provide background information related to the present disclosure and may not constitute prior art.

Lignin is a naturally aromatic macromolecule which can be found in plant cell walls. Due to its complex, three-dimensional molecular structure, lignin has been considered as an alternative to fossil-fuel based chemicals such as aromatic compounds and polyols. A major source of lignin is black liquor, which is commonly produced by the Kraft pulping process.

Conventional methods for extracting lignin from black liquor use materials such as carbon dioxide and sulfuric acid to precipitate lignin from the black liquor. However, the resulting precipitated lignin is in a solid state and displays a wide range of molecular weight (i.e., 1,000 to 100,000 Daltons). This wide range of molecular weight limits the lignin's applications in commercial products. In order to obtain a more uniform molecular weight of the lignin, these conventional methods include additional fractionation steps such as sequential acid precipitation, solvent extraction, and ultrafiltration. These fractionation steps require additional equipment/materials, time, and cost.

The present disclosure addresses these and other issues related to the separation of lignin from black liquor.

### SUMMARY

This section provides a general summary of the disclosure and is not a comprehensive disclosure of its full scope or all of its features.

The present disclosure provides a method for recovery of lignin, wherein black liquor is dissolved in solvent to form a mixture. In some forms of the present disclosure, a pH of the mixture is greater than or equal to about 12 to less than or equal to about 14. The pH of the mixture is then adjusted to greater than or equal to about 3 to less than or equal to about 7. Next, the mixture is transferred to a pressure reactor to undergo liquefacting.

The liquefacting includes increasing a temperature of the mixture to a target temperature, maintaining the target temperature for a period of time, and cooling the mixture to room temperature. Finally, the mixture is filtered following liquefaction to separate soluble and insoluble fractions of the mixture, wherein the soluble fraction includes a lignin product.

In variations of this method, which may be employed individually or in any combination: the solvent is methanol, a mass ratio of the black liquor to the solvent in the mixture is greater than or equal to about 1:10 to less than or equal to about 1:5, the step of adjusting of the pH of the mixture is done using at least one of an organic acid and an inorganic acid, the target temperature is a temperature greater than or equal to about 100° C. to less than or equal to about 200° C., the period of time during the step of maintaining the target temperature is greater than or equal to about 1 minute to less than or equal to about 15 minutes, a polydispersity of the lignin product is greater than or equal to about 1.78 to less than or equal to about 2.56, and the solvent is recycled after the step of filtering the mixture.

In an aspect of the present disclosure, a foam part for a vehicle includes the lignin product recovered from the method according to the present disclosure.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a flowchart illustrating a method for recovery of lignin according to the present disclosure; and

FIGS. 2A and 2B illustrate exemplary foam parts for a vehicle comprising the lignin product recovered from the method according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Black liquor is a common byproduct of the Kraft pulping process used in the paper industry. Black liquor contains lignin which can be recovered and subsequently used in industrial applications. The present disclosure provides a more efficient method for the recovery of lignin from black liquor as will be discussed in further detail in the following description. The recovered lignin demonstrates a desired narrow molecular weight distribution which allows for use in the production of polyurethane foams and carbon fibers, for example, which can then be used in the manufacture of components for a vehicle.

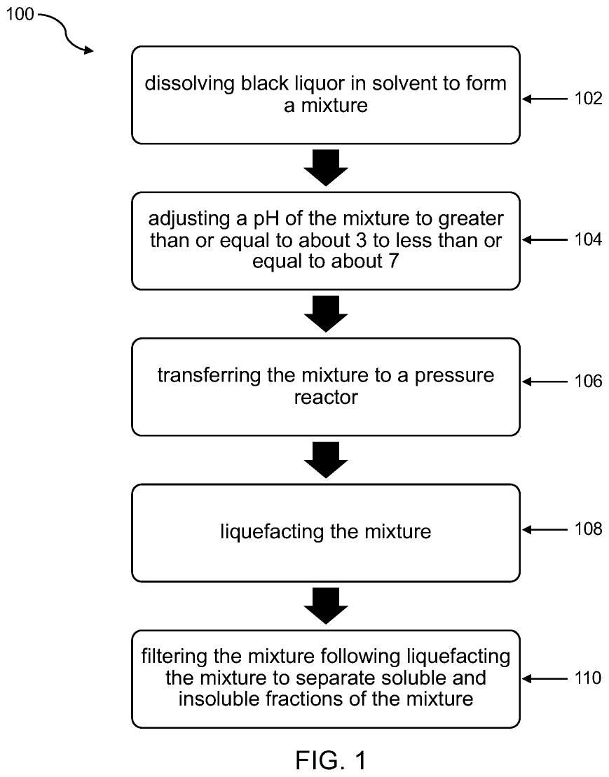

Referring to FIG. 1, a method 100 for the recovery of lignin includes at least partially dissolving black liquor in a solvent, such as methanol, for greater than or equal to about 10 minutes to less than or equal to about 30 minutes at step 102 to form a mixture. Contrary to conventional methods, the lignin is not precipitated out according to the method 100 of the present disclosure. In an aspect, the mixture has a pH greater than or equal to about 12 to less than or equal to about 14. In a variation, a mass ratio of the black liquor to the solvent is greater than or equal to about 1:20 to less than or equal to about 1:3. In another variation, the mass ratio of the black liquor to the solvent is greater than or equal to about 1:20 to less than or equal to about 1:10. In yet another variation, the mass ratio of the black liquor to the solvent is greater than or equal to about 1:10 to less than or equal to about 1:5. In a further variation, the mass ratio of the black liquor to the solvent is greater than or equal to about 1:5 to less than or equal to about 1:3.

At step 104, the pH of the mixture is adjusted to greater than or equal to about 3 to less than or equal to about 7 via addition of at least one of an organic acid and an inorganic acid. By way of non-limiting examples, the organic acid may be acetic acid and the inorganic acid may be sulfuric acid, but it is also contemplated that the pH may be lowered by other organic acids or mixtures of differing organic acids, that the pH may be lowered by other inorganic acids or mixtures of differing organic acids, or that the pH may be lowered by mixtures of inorganic and organic acids. The step 104 of lowering the pH of the mixture provides for an increased recovery rate of lignin.

The mixture is then transferred to a vessel, also referred to as a pressure reactor herein, at step 106 to undergo liquefacting at step 108. More specifically, at step 108, the temperature of the mixture in the pressure reactor is increased to a target temperature. In an aspect, the target temperature is greater than or equal to about 100° C. to less than or equal to about 200° C. In another aspect, the target temperature may be greater than or equal to about 140° C. to less than or equal to about 180° C. The temperature of the mixture in the pressure reactor is increased at a rate of about 5° C./minute.

The mixture in the pressure reactor is then maintained at the target temperature for a period of time. In an aspect, the period of time is greater than or equal to about 1 minute to less than or equal to about 15 minutes. In another aspect, the period of time is greater than or equal to about 3 minutes to less than or equal to about 15 minutes. Lastly, the mixture in the pressure reactor is cooled to room temperature. The cooling may be accomplished using cold water. In one form of the method 100, the mixture is constantly stirred during liquefacting. Contrary to conventional methods, which precipitate lignin into a solid state, the lignin is in a liquified state during the liquefacting of method 100 of the present disclosure.

Following liquefaction, at step 110 the mixture is then filtered to separate soluble and insoluble fractions of the mixture. In an aspect, the insoluble fraction is washed with a solvent, such as methanol, until the filtrate is colorless. The solvent in the soluble fraction is recycled by, for example, rotary evaporation. In an aspect, the soluble fraction is successively oven dried and vacuum dried. In an aspect, the oven drying comprises heating the soluble fraction to about 70° C. In an aspect, the vacuum drying comprises heating the soluble fraction to about 50° C.

Contrary to conventional methods, the method 100 of the present disclosure does not use water or carbon dioxide. Advantageously, the solvent, along with any inorganic acid and/or organic acid, can be recovered and recycled following liquefaction. Furthermore, the recovery rate of lignin for the method 100 according to the present disclosure is up to about 78.5% according to some variations, and can be as high as about 85%.

In an aspect, the lignin product recovered from the method 100 according to the present disclosure has a polydispersity of greater than or equal to about 1.78 to less than or equal to about 2.56. More particularly, the lignin product may have a polydispersity of about 1.8. By comparison, the polydispersity of lignin product recovered from conventional processes ranges from about 2.24 to about 5.36. As used herein, polydispersity shows the breadth or width of the molecular weight distribution and is calculated by dividing the weight average molecular weight by the number average molecular weight (M_{w}/Mₙ). The weight average molecular weight may be greater than or equal to about 1627 Daltons to less than or equal to about 3189 Daltons and the number average molecular weight may be greater than or equal to about 914 Daltons to less than or equal to about 1351 Daltons, for example.

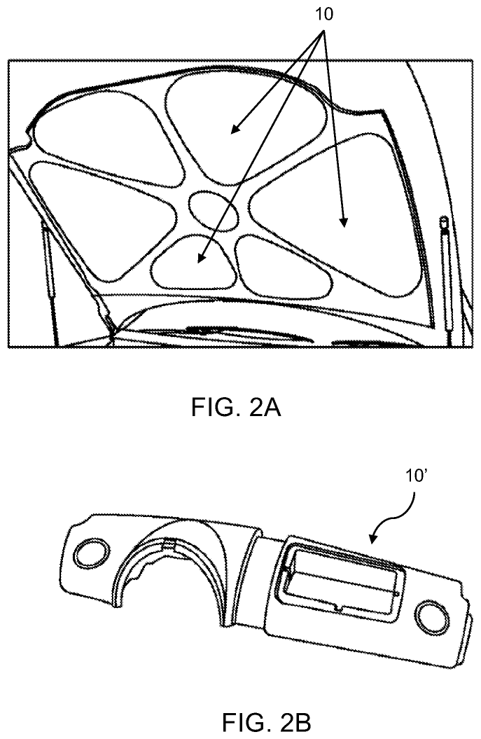

Additionally, the lignin product recovered from the method 100 according to the present disclosure may be used to manufacture a foam part for a vehicle 10, 10′, examples of which are illustrated in FIGS. 2A and 2B. As shown, the foam part for a vehicle 10 is vehicle under hood insulation and the foam part for a vehicle 10′ is a vehicle instrument panel; however, the present disclosure is not limited thereto. For example, the foam part for a vehicle may also be seating components, armrest pads, center console supports, acoustic insulation, pillar components, bumper components, and console components, among others.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for recovery of lignin, the method comprising:
dissolving black liquor in solvent to form a mixture, wherein a pH of the mixture is greater than or equal to about 12 to less than or equal to about 14;
adjusting the pH of the mixture to greater than or equal to about 3 to less than or equal to about 7;
liquefacting the mixture, wherein liquefacting comprises:
increasing a temperature of the mixture to a target temperature;
maintaining the target temperature for a period of time; and
cooling the mixture to room temperature; and
filtering the mixture following liquefacting the mixture to separate soluble and insoluble fractions of the mixture, wherein the soluble fraction comprises a lignin product.

2. The method according to claim 1, wherein the solvent comprises methanol.

3. The method according to claim 1, wherein a mass ratio of the black liquor to the solvent in the mixture is greater than or equal to about 1:10 to less than or equal to about 1:5.

4. The method according to claim 1, wherein the step of adjusting the pH of the mixture is done using at least one of an organic acid and an inorganic acid.

5. The method according to claim 1, wherein the target temperature comprises a temperature greater than or equal to about 100° C. to less than or equal to about 200° C.

6. The method according to claim 1, wherein the period of time during the step of maintaining the target temperature is greater than or equal to about 1 minute to less than or equal to about 15 minutes.

7. The method according to claim 1, wherein a polydispersity of the lignin product is greater than or equal to about 1.78 to less than or equal to about 2.56.

8. The method according to claim 1, wherein the solvent is recycled after the step of filtering the mixture.

9. A foam part for a vehicle comprising the lignin product recovered from the method according to claim 1.

10. A method for recovery of lignin, the method comprising:
dissolving black liquor in solvent to form a mixture;
adjusting a pH of the mixture to greater than or equal to about 3 to less than or equal to about 7;
liquefacting the mixture, wherein liquefacting comprises:
increasing a temperature of the mixture to a target temperature;
maintaining the target temperature for a period of time; and
cooling the mixture to room temperature; and
filtering the mixture following liquefacting the mixture to separate soluble and insoluble fractions of the mixture, wherein the soluble fraction comprises a lignin product, wherein a polydispersity of the lignin product is greater than or equal to about 1.78 to less than or equal to about 2.56.

11. The method according to claim 10, wherein the solvent comprises methanol.

12. The method according to claim 10, wherein a mass ratio of the black liquor to the solvent in the mixture is greater than or equal to about 1:10 to less than or equal to about 1:5.

13. The method according to claim 10, wherein the step of adjusting of the pH of the mixture is done using at least one of an organic acid and an inorganic acid.

14. The method according to claim 10, wherein the target temperature comprises a temperature greater than or equal to about 100° C. to less than or equal to about 200° C.

15. The method according to claim 10, wherein the period of time during the step of maintaining the target temperature is greater than or equal to about 1 minute to less than or equal to about 15 minutes.

16. A method for recovery of lignin, the method comprising:
dissolving black liquor in methanol to form a mixture;
adjusting a pH of the mixture to greater than or equal to about 3 to less than or equal to about 7 using at least one of an organic acid and an inorganic acid;
liquefacting the mixture, wherein liquefacting comprises:
increasing a temperature of the mixture to a target temperature;
maintaining the target temperature for a period of time; and
cooling the mixture to room temperature; and
filtering the mixture following liquefacting the mixture to separate soluble and insoluble fractions of the mixture, wherein the soluble fraction comprises a lignin product.

17. The method according to claim 16, wherein a mass ratio of the black liquor to methanol in the mixture is greater than or equal to about 1:10 to less than or equal to about 1:5.

18. The method according to claim 16, wherein the target temperature comprises a temperature greater than or equal to about 100° C. to less than or equal to about 200° C.

19. The method according to claim 16, wherein the period of time during the step of maintaining the target temperature is greater than or equal to about 1 minute to less than or equal to about 15 minutes.

20. The method according to claim 16, wherein a polydispersity of the lignin product is greater than or equal to about 1.78 to less than or equal to about 2.56.
